(19) United States
(12) Patent Application Publication
(10) Pub. No.: US 2008/0214711 A1
(43) Pub. Date: Sep. 4, 2008

(54) HARD COATS WITH A CATIONIC ACRYLIC POLYMER

(75) Inventors: Shan Cheng, Sewickley, PA (US); David R. Fenn, Allison Park, PA (US); Brian K. Rearick, Allison Park, PA (US); Steven R. Zawacky, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/116,502

(22) Filed: May 7, 2008

Related U.S. Application Data
(63) Continuation-in-part of application No. 11/116,579, filed on Apr. 28, 2005.

(51) Int. Cl. C09D 131/02; C08F 20/06; C08F 220/46; C08F 28/02; C08F 230/08; C08F 18/04; C08L 33/02; C08K 5/541

(52) U.S. Cl. 524/265; 526/317.1; 526/286; 526/279; 526/310; 526/314; 524/556

(57) ABSTRACT

A hard coat composition comprising a cationic acrylic polymer is disclosed. The hard coat is suitable for application to a substrate, and can be used without an adhesive promoting primer.

### CROSS-REFERENCE TO RELATED APPLICATIONS

This application is a continuation-in-part of U.S. patent application Ser. No. 11/116,579, filed Apr. 28, 2005, which is incorporated herein by reference.

### FIELD OF THE INVENTION

The present invention relates to hard coat compositions comprising a cationic acrylic polymer.

### BACKGROUND INFORMATION

Plastic substrates, including transparent plastic substrates, are desired for a number of applications, such as windshields, lenses and consumer electronics. To minimize scratching, as well as other forms of degradation, clear “hard coats” are often applied as protective layers to the substrates. A primer is often used to enhance adhesion between the hard coat and the substrate. Hard coats that adhere to these substrates without the use of a primer are desired.

### SUMMARY OF THE INVENTION

The present invention is directed to hard coat compositions comprising a cationic acrylic polymer. The present invention is further directed to a method for improving adhesion of a hard coat to a substrate comprising adding to the hard coat a composition comprising a cationic acrylic polymer. The present invention is also directed to a method for improving a property of a substrate comprising applying to the substrate a coating comprising a cationic acrylic polymer.

### DETAILED DESCRIPTION OF THE INVENTION

The present invention is directed to hard coat compositions comprising a cationic acrylic polymer resin. The term “hard coat”, as used herein, refers to a clear coat that offers one or more of chip resistance, impact resistance, abrasion resistance, UV degradation resistance, humidity resistance and/or chemical resistance. Any composition that comprises a cationic acrylic polymer can be used according to the present invention. A “cationic acrylic polymer” refers to acrylic polymers that comprise cationic functional groups that impart a positive charge.

The cationic acrylic polymer can be formed by any means known in that art. Suitable cationic acrylic polymers include, for example, copolymers of one or more alkyl esters of acrylic acid or methacrylic acid, optionally together with one or more other polymerizable ethylenically unsaturated monomers. Suitable alkyl esters of acrylic acid or methacrylic acid include, without limitation, methyl methacrylate, ethyl methacrylate, butyl methacrylate, ethyl acrylate, butyl acrylate, and 2-ethyl hexyl acrylate. Suitable other copolymerizable ethylenically unsaturated monomers include nitrites, such as acrylonitrile and methacrylonitrile, vinyl and vinylidene halides, such as vinyl chloride and vinylidene fluoride, and vinyl esters, such as vinyl acetate, among other monomers. Acid and anhydride functional ethylenically unsaturated monomers, such as acrylic acid, methacrylic acid or anhydride, itaconic acid, maleic acid or anhydride, or fumaric acid may be used. Amide functional monomers including, without limitation, acrylamide, methacrylamide, and N-alkyl substituted (meth)acrylamides are also suitable. Vinyl aromatic compounds, such as styrene and vinyl toluene, can also be used in certain cases.

Functional groups, such as hydroxyl and amino groups, can be incorporated into the acrylic polymer by using functional monomers; such as hydroxyalkyl acrylates and methacrylates or aminoalkyl acrylates and methacrylates. Epoxide functional groups (for conversion to cationic salt groups) may be incorporated into the acrylic polymer by using functional monomers, such as glycidyl acrylate and methacrylate, 3,4-epoxycyclohexylmethyl (meth)acrylate, 2-(3,4-epoxycyclohexyl)ethyl(meth)acrylate, or allyl glycidyl ether. Alternatively, epoxide functional groups may be incorporated into the acrylic polymer by reacting carboxyl groups on the acrylic polymer with an epihalohydrin or dihalohydrin, such as epichlorohydrin or dichlorohydrin.

Suitable acrylic polymers can be prepared by traditional free radical initiated polymerization techniques, such as solution polymerization techniques, as known in the art using suitable catalysts, which include organic peroxides and azo type compounds, and optionally chain transfer agents, such as alpha-methyl styrene dimer and tertiary dodecyl mercaptan.

In certain embodiments, the cationic acrylic polymer can be an amino group containing resin that is rendered cationic by at least partial neutralization of the amino groups with an acid. Suitable acids include organic and inorganic acids such as formic acid, acetic acid, lactic acid, phosphoric acid, dimethylolpropionic acid and sulfamic acid. Mixtures of acids can be used. In certain embodiments, the resin can contain primary, secondary and/or tertiary amino groups. Amino groups can be introduced into the copolymer directly by using an amino group containing monomer such as an aminoalkyl (meth)acrylate, for example, dimethylaminopropyl methacrylate. Alternatively the amino groups can be derived from the reaction of an epoxide functional acrylic polymer with a compound containing a primary or secondary amine group, such as methylamine, diethanolamine, ammonia, diisopropanolamine, N-methyl ethanolamine, diethylenetriamine, dipropylenetriamine, bishexamethylenetriamine, the diketimine of diethylenetriamine, the diketimine of dipropylenetriamine, the diketimine of bishexamethylenetriamine and mixtures thereof. Non-limiting examples of suitable cationic acrylic polymers containing amino groups include those resins described in U.S. Pat. Nos. 3,455,806 and 3,928,157 and published application 2003/0054193 A1, all of which are hereby incorporated by reference.

In certain embodiments, the cationic acrylic polymer can be a sulfonium salt group containing resin. Sulfonium salt groups can be introduced by the reaction of an epoxy group with a sulfide in the presence of an acid. Suitable cationic acrylic polymers containing sulfonium salt groups include those resins described in U.S. Pat. Nos. 3,959,106, and 4,038,232, and published application 2003/0098238, all of which are hereby incorporated by reference.

In certain embodiments, the cationic acrylic polymer contains 0.01 to 3, such as 0.1 to 1, milliequivalents of cationic salt groups per gram of polymer solids.

The hard coat compositions of certain embodiments of the present invention can further comprise an alkoxide having the general formula RₓM(OR′)_{z-x} where R is an organic radical, M is silicon, aluminum, titanium, and/or zirconium, each R′ is independently an alkyl radical, z is the valence of M, and x is a number less than z and may be zero. Examples of suitable organic radicals include, but are not limited to, alkyl, vinyl, methoxyalkyl, phenyl, γ-glycidoxy propyl and/or γ-methacryloxy propyl. The alkoxide can be unhydrolyzed, partially hydrolyzed or fully hydrolyzed. The alkoxide can be further mixed and/or reacted with other compounds and/or polymers known in the art, such as compositions comprising siloxanes formed from at least partially hydrolyzing an organoalkoxysilane, such as one within the formula above. Examples of suitable alkoxide-containing compounds and methods for making them are described in U.S. Pat. Nos. 6,355,189; 6,264,859; 6,469,119; 6,180,248; 5,916,686; 5,401,579; 4,799,963; 5,344,712; 4,731,264; 4,753,827; 4,754,012; 4,814,017; 5,115,023; 5,035,745; 5,231,156; 5,199,979; and 6,106,605, all of which are incorporated by reference herein. A suitable commercially available alkoxide hard coat from PPG Industries, Inc. is SOLGARD 330.

The hard coat compositions of the present invention can also include one or more standard additives, such as UV absorbers, flow additives, rheology modifiers, adhesion promoters, catalysts, pigments, dyes and the like. In certain embodiments, the UV absorber is silylated. Silylated UV absorbers are commercially available from Gelest, Inc. It may also be desired to add crosslinkers, to react with any functionality introduced by the acrylic or the compound used to form the salt.

Typically, the cationic acrylic polymer will be present in the hard coat composition in an amount of 1 to 25 weight percent, such as 2 to 15 or 5 to 10 weight percent, with weight percent being based on the total solid weight of the composition. When an alkoxide is also used in the composition, it will typically comprise 50 to 99 weight percent, based on total solid weight.

If a cationic acrylic polymer is used with a partially or fully hydrolyzed alkoxide, it can simply be added to the alkoxide with stirring. In certain embodiments, rather than post-adding a cationic acrylic polymer to an unhydrolyzed or partially hydrolyzed alkoxide coating, the alkoxysilane precursors and cationic acrylic polymer can be co-hydrolyzed. This can be done using methods standard in the art. A silylated UV absorber can also be used in the reaction.

Acrylics may not be compatible with partially or fully hydrolyzed alkoxide. Forming the cationic salt of the acrylic helps to compatibilize the acrylic and alkoxide.

In certain embodiments of the present invention, the hard coat composition does not comprise a polycaprolactone polyol, and/or a (meth)acrylate that is not in cationic salt form.

In certain embodiments, the cationic acrylic polymer that is used in the hardcoat compositions of the present invention is substantially free of UV-absorbing groups, such as those derived from (i) benzotriazole, (ii) benzophenone, and (iii) triazine. In other words, in these embodiments, the monomers from which the cationic acrylic polymer is derived are substantially free of UV absorbing group-bearing vinyl polymerizable monomers. As used herein, the term “substantially free”, when used with reference to the absence of UV-absorbing groups in the cationic acrylic polymer, means that the cationic acrylic polymer is obtained by copolymerizing monomers wherein less than 5% by weight, in some cases no more than 2% by weight, of the total monomers used to obtain the cationic acrylic polymer are UV absorbing group-bearing vinyl polymerizable monomers, particularly those selected from (i) benzotriazole, (ii) benzophenone, and (iii) triazine.

In certain embodiments, the cationic acrylic polymer that is used in the hardcoat compositions of the present invention is completely free of UV-absorbing groups, such as those derived from (i) benzotriazole, (ii) benzophenone, and (iii) triazine. As used herein, the term “completely free”, when used with reference to the absence of UV-absorbing groups in the cationic acrylic polymer, means that the cationic acrylic polymer is obtained by copolymerizing monomers wherein no UV absorbing group-bearing vinyl polymerizable monomers, particularly those selected from (i) benzotriazole, (ii) benzophenone, and (iii) triazine, are used to obtain the cationic acrylic polymer.

The present invention is also directed to a method for improving adhesion between a hard coat and a substrate comprising adding to the hard coat a cationic acrylic polymer. The cationic acrylic polymer is as described above. Any amount of improved adhesion is within the scope of the present invention; whether improved adhesion is observed can be easily determined using testing standard in the art, such as cross hatch tape adhesion testing, abrasion resistance testing and the like. Comparing the results obtained with a hard coat both with and without the cationic acrylic polymer described above will indicate whether improved adhesion is achieved.

The present invention is further directed to a method for improving a property of a substrate comprising applying to the substrate a coating comprising a cationic acrylic polymer, such as any of the coatings described above. As used herein, “improving a property” and like terms refers to improving a property of the substrate such as chip resistance, impact resistance, abrasion resistance, UV degradation resistance, humidity resistance and/or chemical resistance including but not limited to alkali resistance.

Suitable substrates that can be treated according to the present invention generally include plastic substrates, such as thermoplastic substrates, including but not limited to polycarbonates, acrylonitrile butadiene styrene, blends of polyphenylene ether and polystyrene, polyetherimides, polyesters, polysulfones, acrylics, and copolymers and/or blends of any of these. The coating comprises the cationic acrylic polymer, as described above. The coating can also further comprise an alkoxide and/or any standard additives, also as described above.

The coating composition can be applied to the substrate by any means known in the art, such as spraying, dipping, roll coating, flow coating, brushing, and the like. The coating can then be cured, such as by flashing the coating at ambient temperature for up to one hour, and then baking the coating at an appropriate temperature and time, which can be determined by one skilled in the art based upon the particular coating and/or substrate being used. It will be appreciated that any suitable cure conditions can be used, and will depend on the particular formulation of the coating applied. The dry film thickness of the coating on the substrate can be from 1 to 10 microns, such as 5 to 7 microns. The coating can be applied directly to the substrate without a primer or other intervening layer with suitable adhesion being observed.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the coatings of the present invention have been described in terms of “a” cationic acrylic polymer, one or more such acrylics can be used. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

### Example 1

The coating solutions were prepared as follows: A cationic acrylic polymer adhesion promoter solution was added into alkoxysilane hard coat solutions (SOLGARD 330, from PPG Industries, Inc.) under stirring as indicated in Table 1 below.

MOKROLON polycarbonate substrate from Bayer was wiped and rinsed with 2-propanol. Coatings were flow or spray applied on un-primed substrate and flashed at ambient for 5 minutes. The coated polycarbonate was baked at 120° C. for 3 hours. The dry film thickness of the coating was 5-10 μm. Coated panels were tested for adhesion and taber abrasion resistance.

As demonstrated in Table 1, coatings without the cationic acrylic polymer adhesion promoter did not provide acceptable adhesion. Without acceptable adhesion, coatings do not exhibit abrasion resistance. Therefore only the samples that passed the adhesion test were evaluated for taber abrasion resistance.

TABLE 1
Compositional Information on Primerless Hard Coat Formulations
and Performance

| | Example | | | | |
|---|---|---|---|---|---|
| | 1 | 2 | 3 | 4 | 5 |
| Component A* | | | | | |
| Pre-hydrolyzed | 25 | 25 | 25 | 20 | 15 |
| Alkoxysilane Coating¹ | | | | | |
| Solvent² | 25 | 25 | 25 | 20 | 15 |
| Component B* | | | | | |
| Amine Salt Cationic | — | 0.20 | 1.0 | — | — |
| acrylic polymer Resin | | | | | |
| Solution³ | | | | | |
| Amine Salt Cationic | — | — | — | 0.12 | — |
| acrylic polymer Resin | | | | | |
| Solution⁴ | | | | | |
| Sulfonium Salt Cationic | — | — | — | — | 0.09 |
| acrylic polymer Resin | | | | | |
| Solution⁵ | | | | | |
| Melamine Resin | — | 0.03 | 0.13 | — | — |
| Solution⁶ | | | | | |
| Acid Catalyst⁷ | — | 0.01 | 0.06 | — | — |
| Solvent⁸ | — | 0.26 | 1.32 | 0.68 | 0.51 |
| Testing | Results | | | | |
| Appearance⁹ | Clear | Clear | Clear | Clear | Slightly |
| | | | | | milky |
| Initial Haze %¹⁰ | — | 0.2 | 0.3 | 1.2 | 3.6 |
| Adhesion¹¹ | — | 5 | 5 | 5 | 5 |
| Delta Haze % after | — | 12 | 18 | 16 | — |
| Taber Abrasion¹² | | | | | |

*Based on weight of each component.
¹SOLGARD ™ 330, PPG Industries, Inc.
²1-propanol.
³Amine salt cationic acrylic polymer resin, Mw = 12300, 57% total solid, prepared according to Example 2.
⁴Amine salt cationic resin, Mw − 22400, 56% total solid, prepared according to Example 3.
⁵Sulfonium salt acrylic resin, Mw = 22400, 57% total solid, prepared according to Example 4.
⁶CYMEL 327, Cytec Industries Inc.
⁷Phenyl acid phosphate solution, KOCK Chemical. Diluted to 10% in 1-propanol.
⁸1-propanol.
⁹As visually observed after cure.
¹⁰Measured with Ultra Scan XE spectrophotometer from Hunter Associates Laboratory.
¹¹Adhesion: Crosshatch, Nichibon LP-24 adhesive tape. Rating scale 0-5 (0 = no adhesion; 5 = 100% adhesion after tape peeling).
¹²Taber Abrasion: Taber 5150 Abrader, CS-10 wheels, 500 grams weight. Haze % was measured after 500 tabor abrasion cycles.

### Example 2

| | | Charge Weight |
|---|---|---|
| A | Butyl Cellosolve¹³ | 135.3 |
| | Deionized water | 14.0 |
| B | Butyl acrylate | 49.0 |
| | Methyl methacrylate | 56.0 |
| | Styrene | 350.0 |
| | Glycidyl methacrylate | 105.0 |
| | Hydroxypropyl methacrylate | 140.0 |
| | t-Dodecyl mercaptan | 23.0 |
| | VAZO 67¹⁴ | 17.6 |
| | Butyl Cellosolve | 14.0 |
| C | LUPEROX 26¹⁵ | 7.3 |
| | Butyl Cellosolve | 29.5 |
| D | Diethanolamine | 73.5 |
| | Butyl Cellosolve | 6.7 |
| E | Butyl Cellosolve | 3.3 |
| F | Deionized water | 37.5 |
| G | n-Propanol | 274.5 |
| H | 88% Lactic Acid¹⁶ | 57.3 |
| I | n-Propanol | 100.0 |

¹³Ethyleneglycol monobutyl ether available from Dow Chemical Co.
¹⁴2,2′-azobis(2-methylbutyronitrile) available from E. I. DuPont de Nemours & Co.
¹⁵t-Butyl peroxy-2-ethylhexanoate available from Arkema.
¹⁶88% aqueous lactic acid available from Purac America Inc.

### Resin Preparation Method

Charge A was added to a flask fitted with a nitrogen inlet, stirrer, condenser and thermocouple. The mixture was heated to 100 to 105° C. and charge B was then added dropwise at a uniform rate over 2½ hours while maintaining the reaction temperature between 100 to 105° C. After charge B was in, the mixture was held at temperature a further 30 minutes, and then charge C was added at a uniform rate over 15 minutes while maintaining the reaction temperature at 100 to 105° C. After an additional 30 minutes hold at temperature, the temperature raised to 110 to 115° C. When the temperature had stabilized, charge D was added at once and the mixture allowed to exotherm and then was held at 120 to 125° C. for 2 hours. When the hold was over, Charges E and F were added while the reaction mixture was cooled to 90 to 95° C. When the temperature was reached, Charges G, H and I were added dropwise in turn to give the final product. The material was filled out warm and cooled to give a resin with 57.14% solids and a measured meq acid of 0.329 and meq base of 0.496 per gram.

### Example 3

| | | Charge Weight |
|---|---|---|
| A | Butyl Cellosolve¹⁷ | 135.3 |
| | Deionized water | 14.0 |
| B | Butyl acrylate | 49.0 |
| | Methyl methacrylate | 56.0 |
| | Styrene | 350.0 |
| | Glycidyl methacrylate | 35.0 |
| | Hydroxypropyl methacrylate | 210.0 |
| | t-Dodecyl mercaptan | 7.0 |
| | VAZO 67¹⁸ | 17.5 |
| | Butyl Cellosolve | 14.0 |
| C | LUPEROX 26¹⁹ | 7.3 |
| | Butyl Cellosolve | 29.5 |
| D | Butyl Cellosolve | 13.6 |
| E | Diethanolamine | 24.5 |
| | Butyl Cellosolve | 6.7 |
| F | Deionized water | 37.5 |
| G | n-Propanol | 274.5 |
| H | 88% Lactic Acid²⁰ | 19.1 |
| I | n-Propanol | 105.1 |

¹⁷Ethyleneglycol monobutyl ether available from Dow Chemical Co.
¹⁸2,2′-azobis(2-methylbutyronitrile) available from E. I. DuPont de Nemours & Co.
¹⁹t-Butyl peroxy-2-ethylhexanoate available from Arkema.
²⁰88% aqueous lactic acid available from Purac America Inc.

### Resin Preparation Method

Charge A was added to a flask fitted with a nitrogen inlet, stirrer, condenser and thermocouple. The mixture was heated to 100 to 105° C. and charge B was then added dropwise at a uniform rate over 2½ hours while maintaining the reaction temperature between 100 to 105° C. After charge B was in, the mixture was held at temperature a further 30 minutes, and then charge C was added at a uniform rate over 15 minutes while maintaining the reaction temperature at 100 to 105° C. After an additional 30 minutes hold at temperature, the temperature raised to 110 to 115° C. while adding charge D. When the temperature had stabilized, charge E was added at once and the mixture allowed to exotherm and then was held at 120 to 125° C. for 2 hours. When the hold was over, Charge F was added while the reaction mixture was cooled to 90 to 95° C. When the temperature was reached, Charges G, H and I were added dropwise in turn to give the final product. The material was filled out warm and cooled to give a resin with 55.5% solids and a measured meq acid of 0.117 and meq base of 0.173 per gram.

### Example 4

| | | Charge Weight |
|---|---|---|
| A | Butyl Cellosolve²¹ | 135.3 |
| | Deionized water | 14.0 |
| B | Butyl acrylate | 49.0 |
| | Hydroxypropyl methacrylate | 210.0 |
| | Methyl methacrylate | 56.0 |
| | Styrene | 350.0 |
| | Glycidyl methacrylate | 35.0 |
| | t-Dodecyl mercaptan | 7.0 |
| | VAZO 67²² | 17.5 |
| | Butyl Cellosolve | 14.0 |
| C | LUPEROX 26²³ | 7.3 |
| | Butyl Cellosolve | 29.5 |
| D | Butyl Cellosolve | 20.3 |
| E | Thiodiethanol | 56.9 |
| | Acetic acid | 14.0 |
| | Deionized water | 21.0 |
| F | n-Propanol | 396.7 |

²¹Ethyleneglycol monobutyl ether available from Dow Chemical Co.
²²2,2′-azobis(2-methylbutyronitrile) available from E. I. DuPont de Nemours & Co.
²³t-Butyl peroctoate available from Arkema.

### Resin Synthesis Procedure

### (i) Polymerization Stage

Components A were charged to a flask fitted with a nitrogen inlet, stirrer, condenser and thermocouple. The temperature was increased to 100° C. and this temperature was maintained throughout the polymerization stage. Components B were then added at a uniform rate over 1.50 minutes. 30 minutes later, components C were added over about 10 minutes. After a further 30 minutes, the heat source was removed and the reaction mixture was allowed to cool.

### (ii) Sulfonium Stage

Once the temperature had reached 80° C., the heat source was replaced and components D and E were added. The temperature was adjusted back to 80° C. and maintained for 5 hours. Titration of a sample at this stage revealed that the sulfonium content was 0.053 milliequivalents/g, the epoxy equivalent weight was 8655 and the acid value was 8.0. Component F was added and the resin solution was allowed to cool to room temperature.

Whereas particular embodiments of this invention have been described above for purposes of illustration, it will be evident to those skilled in the art that numerous variations of the details of the present invention may be made without departing from the invention as defined in the appended claims.

What is claimed is:

1. A hard coat composition comprising a cationic acrylic polymer that is substantially free of UV-absorbing groups derived from (i) benzotriazole, (ii) benzophenone, and (iii) triazine.

2. The composition of claim 1, wherein the cationic acrylic polymer contains a sulfonium moiety.

3. The composition of claim 1, wherein the cationic acrylic polymer comprises glycidyl (meth)acrylate.

4. The composition of claim 1, wherein the cationic acrylic polymer contains 0.01 to 3 milliequivalents of cationic salt groups per gram of polymer solids.

5. The composition of claim 1, further comprising an alkoxide.

6. The composition of claim 5, wherein the alkoxide is organoalkoxysilane.

7. The composition of claim 6, wherein the organoalkoxysilane is partially or fully hydrolyzed.

8. A method for improving adhesion between a hard coat and a substrate, comprising adding to the hard coat a cationic acrylic polymer that is substantially free of UV-absorbing groups derived from (i) benzotriazole, (ii) benzophenone, and (iii) triazine.

9. The method of claim 8, wherein the substrate is thermoplastic.

10. The method of claim 9, wherein the substrate comprises polycarbonate.

11. The method of claim 8, wherein the composition further comprises an alkoxide.

12. The method of claim 11, wherein the alkoxide is organoalkoxysilane.

13. The method of claim 12, wherein the organoalkoxysilane is partially or fully hydrolyzed.

14. A hard coat composition comprising a cationic acrylic polymer that is the reaction product of one or more monomers selected from the group consisting of:
(a) an alkyl ester of acrylic acid;
(b) an alkyl ester of methacrylic acid;
(c) a nitrite;
(d) a vinyl halide;
(e) a vinylidene halide;
(f) a vinyl ester;
(g) an acid functional ethylenically unsaturated monomer;
(h) an anhydride functional ethylenically unsaturated monomer;
(i) an amide functional monomer;
(j) a vinyl aromatic compound;
(k) a hydroxy alkyl acrylate;
(l) a hydroxy alkyl methacrylate;
(m) an amino alkyl methacrylate;
(n) a glycidyl acrylate; and
(o) a glycidyl methacrylate.

15. The composition of claim 14, wherein the cationic acrylic polymer contains a sulfonium moiety.

16. The composition of claim 14, wherein the cationic acrylic polymer comprises glycidyl (meth)acrylate.

17. The composition of claim 14, wherein the cationic acrylic polymer contains 0.01 to 3 milliequivalents of cationic salt groups per gram of polymer solids.

18. The composition of claim 14, further comprising an alkoxide.

19. The composition of claim 18, wherein the alkoxide is organoalkoxysilane.

20. The composition of claim 19, wherein the organoalkoxysilane is partially or fully hydrolyzed.
